(19) United States
(12) Patent Application Publication
(10) Pub. No.: US 2017/0302827 A1
(43) Pub. Date: Oct. 19, 2017

(54) LIGHT-SHEET MICROSCOPE AND SAMPLE OBSERVATION METHOD

(71) Applicant: OLYMPUS CORPORATION, Tokyo (JP)

(72) Inventor: Yoshihiro SHIMADA, Kanagawa (JP)

(73) Assignee: OLYMPUS CORPORATION, Tokyo (JP)

(21) Appl. No.: 15/477,282

(22) Filed: Apr. 3, 2017

(30) Foreign Application Priority Data
Apr. 14, 2016 (JP) 2016-080989

(51) Int. Cl. H04N 5/04; G02B 21/26; G02B 21/02; G02B 21/16; G02B 21/36

(52) U.S. Cl. CPC H04N 5/04; G02B 21/362; G02B 21/361; G02B 21/02; G02B 21/16; G02B 21/26

(57) ABSTRACT

In order to simply and accurately acquire a three-dimensional image of a sample to observe the sample, a light-sheet microscope according to the present invention includes: a duct in which the sample can flow; a syringe pump for moving the sample in the duct; a cylindrical lens for causing planar illumination light along a plane intersecting the direction in which the sample is moved by the syringe pump to enter the duct; an objective lens that is disposed so as to face the radiation plane of the illumination light caused by the cylindrical lens to enter the duct and that collects fluorescence emitted from the sample moved by the syringe pump so as to pass through the radiation plane of the illumination light; and a camera for acquiring an image of the fluorescence from the sample collected by the objective lens.

### CROSS-REFERENCE TO RELATED APPLICATIONS

This application is based on Japanese Patent Application No. 2016-080989, the contents of which are incorporated herein by reference.

### TECHNICAL FIELD

The present invention relates to a light-sheet microscope and a sample observation method.

### BACKGROUND ART

There is a known light-sheet microscope (refer to, for example, Patent Literature 1 and Patent Literature 2). Light-sheet microscopes are also gaining attention as a technique that can be applied to so-called drug development screening, in which a three-dimensional image of a spheroid or an organoid (an artificial organ or a portion thereof), like three-dimensional cultured cells, is acquired to evaluate pharmaceutical efficacy by an image analysis technique.

For drug development screening, in general, a multi-well plate is used to set a plurality of test conditions. For example, a plurality of drugs with different concentrations or a plurality of different cell types are prepared, these drugs or cell types are assigned to wells of the multi-well plate, and the pharmaceutical efficacy thereof is evaluated from the obtained analysis results.

In such drug development screening, it will not be suitable to use, for example, a confocal microscope from the viewpoint of damage to the sample, such as fluorescence photo bleaching, as well as throughput, when carrying out cell screening by obtaining a three-dimensional image of a sample having a three-dimensional structure. Because of this, there is a growing demand for the use of light-sheet microscopes, which exhibit a high throughput and cause less damage to the sample.

### CITATION LIST

### Patent Literature

{PTL 1}

U.S. Pat. No. 7,554,725

{PTL 2}

PCT International Publication No. 2015/184124

### SUMMARY OF INVENTION

### Technical Problem

In the basic configuration of a light-sheet microscope, it is necessary that the illumination light path be orthogonal to the observation light axis, which hampers the use of a multi-well plate as is. Furthermore, Patent Literatures 1 and 2 do not describe an optimal method for acquiring an image of a relatively small sample with a three-dimensional structure, such as a spheroid (with a diameter of 0.1 mm to 1 mm).

### Solution to Problem

The present invention provides a light-sheet microscope and a sample observation method that allow a three-dimensional image of a sample to be easily and accurately acquired to observe the sample.

One aspect of the present invention is a light-sheet microscope including: a duct in which a sample can flow; a sample moving part for moving the sample in the duct; an illuminating section for causing planar illumination light along a plane intersecting the direction in which the sample is moved by the sample moving part to enter the duct; an objective lens that is disposed so as to face a radiation plane of the illumination light caused by the illuminating section to enter the duct and that collects light emitted from the sample moved by the sample moving part so as to pass through the radiation plane of the illumination light; and an image-capturing unit for acquiring an image of the light that comes from the sample and that is collected by the objective lens.

Another aspect of the present invention is a sample observation method including: injecting a sample into a duct; causing planar illumination light along a plane intersecting a flow direction of the sample in the duct to enter the duct; moving the sample in the duct so that the sample passes through a radiation plane of the illumination light caused to enter the duct; and acquiring an image of light emitted from the sample passing through the radiation plane of the illumination light.

### BRIEF DESCRIPTION OF DRAWINGS

FIG. 1A is a longitudinal sectional view showing a state in which samples reside in a bypass section of a duct in a light-sheet microscope according to a first embodiment of the present invention.

FIG. 1B is a diagram as viewed from below in the vertical direction of the light-sheet microscope in FIG. 1A.

FIG. 2 is a flowchart illustrating a sample observation method according to the first embodiment of the present invention.

FIG. 3 is a longitudinal sectional view showing the behavior of samples passing through a radiation plane of illumination light in the duct of the light-sheet microscope according to the first embodiment of the present invention.

FIG. 4 is a longitudinal sectional view showing the behavior of the samples being discharged from an outlet of the duct into a container in the light-sheet microscope according to the first embodiment of the present invention.

FIG. 5 is a longitudinal sectional view showing a state in which the samples, which have been discharged from the duct into the container, are being collected with a pipette in the light-sheet microscope according to the first embodiment of the present invention.

FIG. 6A is a longitudinal sectional view showing a state in which samples reside in a bypass section of a duct in a light-sheet microscope according to a second embodiment of the present invention.

FIG. 6B is a diagram as viewed from below in the vertical direction of the light-sheet microscope in FIG. 6A.

FIG. 7 is a longitudinal sectional view showing the behavior of samples passing through a radiation plane of illumination light in the duct of the light-sheet microscope according to the second embodiment of the present invention.

FIG. 8 is a longitudinal sectional view showing behavior of the samples being suctionally attracted close to an outlet section of the duct in the light-sheet microscope according to the second embodiment of the present invention.

FIG. 9 is a longitudinal sectional view showing a state in which the samples, which have been pushed back to an inlet of the duct, are being sucked up with a pipette in the light-sheet microscope according to the second embodiment of the present invention.

FIG. 10 is a longitudinal sectional view showing the behavior of samples passing through a radiation plane of illumination light in a duct of a light-sheet microscope according to a modification of each of the embodiments of the present invention.

FIG. 11 is a longitudinal sectional view showing a configuration in which planar illumination light along a plane tilted by substantially 45° relative to the sample circulation direction is made incident on the duct in the light-sheet microscope according to the modification of each of the embodiments of the present invention.

### DESCRIPTION OF EMBODIMENTS

### First Embodiment

A light-sheet microscope and a sample observation method according to a first embodiment of the present invention will now be described with reference to the drawings.

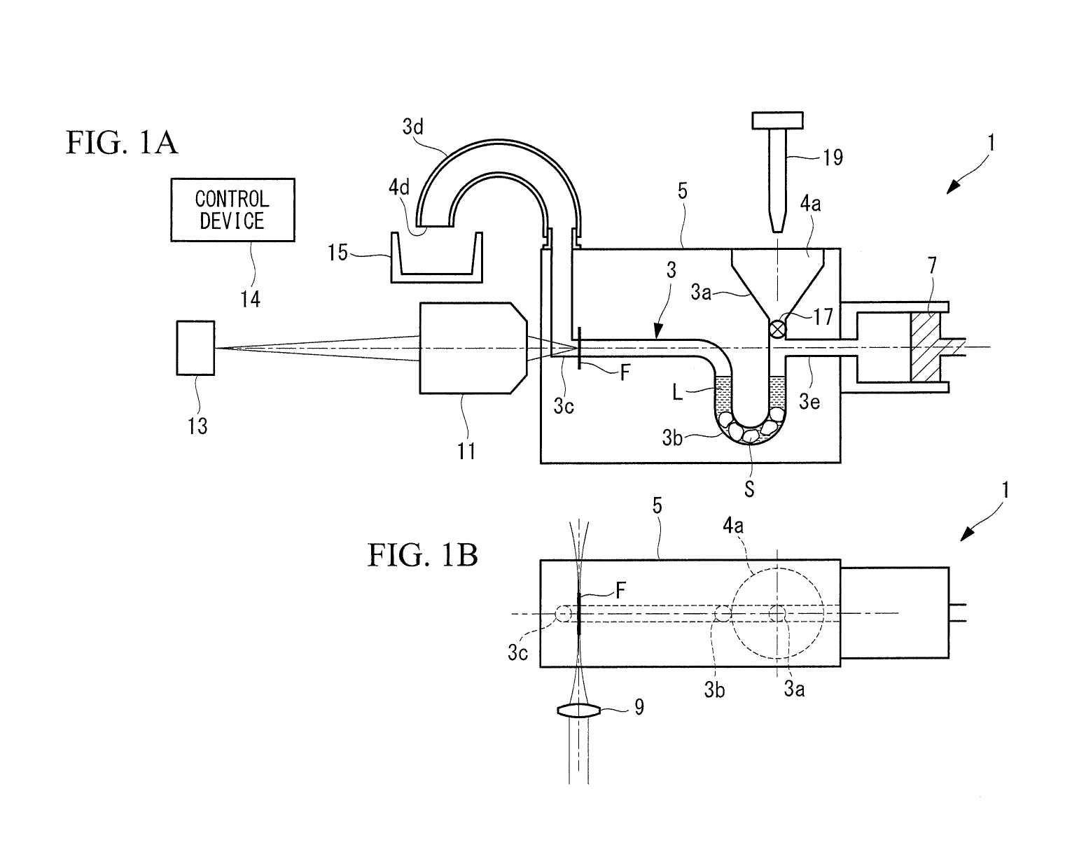

As shown in FIGS. 1A and 1B, a light-sheet microscope 1 according to this embodiment includes: a casing 5 forming a duct 3 in which samples S can flow; a syringe pump (sample moving part) 7 for moving the samples S in the duct 3; a cylindrical lens (illuminating section) 9 that allows planar illumination light to enter the duct 3; an objective lens 11 for collecting fluorescence (light) emitted from the samples S irradiated with the illumination light in the duct 3; a camera (image-capturing unit) 13 for acquiring an image of the fluorescence that comes from the samples S and that is collected by the objective lens 11; and a control device 14 for controlling the syringe pump 7, the camera 13, and so forth.

The light-sheet microscope 1 further includes, in the vicinity of the casing 5, a container-placing part (not shown in the figure) on which a container 15 for accommodating the samples S discharged from the duct 3 can be placed.

The samples S are, for example, substantially spherical spheroids having a three-dimensional structure and cultivated in a multi-well plate, not shown in the figure.

The duct 3 has, for example, a circular shape in cross section and is shaped so as to bend only in one plane orthogonal to the illumination light axis of illumination light. This duct 3 includes, along the flow direction of the samples S in the following order starting at the inlet side: an inlet section 3a having an inlet 4a through which the samples S are injected; a bypass section 3b that runs at a vertically lower point than a radiation plane F of illumination light; a bending section 3c that bends in a direction intersecting the optical axis of the objective lens 11 between the radiation plane F of the illumination light and the objective lens 11; and an outlet section 3d having an outlet 4d through which the samples S having passed through the radiation plane F of the illumination light are discharged.

The inlet section 3a is substantially shaped like a cone having the inlet 4a, in the form of an opening, formed at the top surface of the casing 5 and is tapered vertically downwards from the inlet 4a. The inlet 4a has a diameter larger than the sizes of other sections of the duct 3, such as the bypass section 3b, the bending section 3c, and the outlet section 3d.

The bypass section 3b is disposed vertically below the inlet section 3a. The samples S and a culture fluid (liquid) L injected from the inlet 4a are brought via the inlet section 3a into the bypass section 3b due to the weight thereof. Furthermore, the bypass section 3b is formed in a U shape and can temporarily store the samples S and the culture fluid L brought from the inlet section 3a. It is desirable that this bypass section 3b have a volume larger than the gross volume of the samples S and the culture fluid (liquid) L that are injected together at once. By doing so, the temporarily stored sample S and the culture fluid L can be prevented from overflowing from the bypass section 3b.

The bending section 3c bends upwards in the vertical direction and has an opening formed at the top surface of the casing 5.

The outlet section 3d is, for example, a tube and has one end thereof connected to the bending section 3c of the casing 5, and the outlet 4d at the other end of the outlet section 3d is disposed in the vicinity of the container-placing part.

Furthermore, the duct 3 further includes: a split section 3e that is formed as an opening between the inlet section 3a and the bypass section 3b and that is connected to the syringe pump 7; and a valve 17 disposed between the opening of the split section 3e and the inlet section 3a. The valve 17 is configured to open and close through the control of the control device 14.

The inlet section 3a, the bypass section 3b, and the bending section 3c of this duct 3 are formed as a through-hole in the casing 5, which is formed of a transparent member. The casing 5 is configured of two bonded casing-forming members that separate from each other along the longitudinal direction of the duct 3. These casing-forming members have a refractive index substantially equal to the refractive index of the culture fluid L that is injected into the duct 3 together with the samples S. The casing 5 may be formed of a casing-forming member divided into three or more parts along the longitudinal direction of the duct 3.

A pipetting robot 19, for example, is used as injecting means for injecting the samples S into the duct 3. The pipetting robot 19 is, for example, a general-purpose robot that can be drive-controlled through programming. This pipetting robot 19 is controlled by the control device 14 so as to suck up the samples S along with the culture fluid L from a well of the multi-well plate (not shown in the figure) accommodating the samples S and the culture fluid L and to inject the sucked-up samples S and the culture fluid L into the inlet 4a of the duct 3. In addition, through the control of the control device 14, the pipetting robot 19 can suck up, from the container 15, the samples S and the culture fluid L that have been discharged from the duct 3 and accommodated in the container 15 and can inject the sucked-up samples S and the culture fluid L into the well of the multi-well plate where they were initially placed.

The syringe pump 7 is configured so as to inject air into the duct 3 via the split section 3e. Through the control of the control device 14, this syringe pump 7 can inject air into the duct 3 via the split section 3e in a state where the samples S are stored in the bypass section 3b and the valve 17 is closed. As a result of this, the samples S and the culture fluid L residing in the bypass section 3b are brought to the outlet 4d via the bending section 3c.

Furthermore, as a result of being driven by the control device 14, the syringe pump 7 can continuously move a plurality of samples S along the duct 3. More specifically, through the control device 14, the syringe pump 7 is driven so as to move the samples S at high speed until just before the leading sample S reaches the radiation plane F of illumination light and after all the samples S have finished passing through the radiation plane F, and is driven so as to move the samples S at low speed during the time period from just before the leading sample S reaches the radiation plane F to until all the samples S finish passing through the radiation plane F.

It is desirable that the movement speed of the samples S be set so that the focal range of the objective lens 11 is not exceeded within the exposure time of the camera 13 while the samples S are passing through the radiation plane F. In general, the movement speed of the samples S is determined in a comprehensive manner according to the S/N ratio, resolution, throughput, and so forth desired for an acquired image. Because the number of the samples S to be injected into the duct 3 in a batch is known, the distance by which the samples S are moved can be controlled with the control device 14.

The cylindrical lens 9 is provided laterally with respect to the casing 5 and is placed so as to face the duct 3. This cylindrical lens 9 has refractive power in one direction orthogonal to the illumination light axis and focuses the illumination light that is emitted from alight source, not shown in the figure, along a plane along the illumination light axis so as to take the shape of a sheet having an area larger than the observation field of view (the size of the observation field of view). The cylindrical lens 9 is configured so as to allow the planar illumination light along a plane orthogonal to the direction in which the samples S move to be incident on a linear position just before the duct 3 bends at the bending section 3c.

The objective lens 11 is disposed so as to face the radiation plane F of illumination light that is be made to enter the duct 3 via the cylindrical lens 9. Furthermore, the objective lens 11 is arranged such that the focal plane thereof coincides with the radiation plane F of illumination light and, when the samples S flowing in the duct 3 pass through the radiation plane F of illumination light, collects fluorescence emitted from the samples S.

The camera 13 is driven by the control device 14 and captures the fluorescence that is incident thereon via the objective lens 11 from the samples S passing through the radiation plane F of illumination light, thus acquiring cross-sectional images of the samples S. More specifically, the camera 13 is driven by the control device 14 in synchronization with the movement of the samples S due to the syringe pump 7 and acquires, at prescribed time intervals, a plurality of images of the samples S passing through the radiation plane F of illumination light. By doing so, cross-sectional images of the samples S can be acquired at a plurality of different positions in the direction in which the samples S move, according to the relationship between the moving distance of the samples S due to the syringe pump 7 and the time intervals at which images are acquired with the camera 13.

The control device 14 controls the valve 17, the pipetting robot 19, the syringe pump 7, and the camera 13.

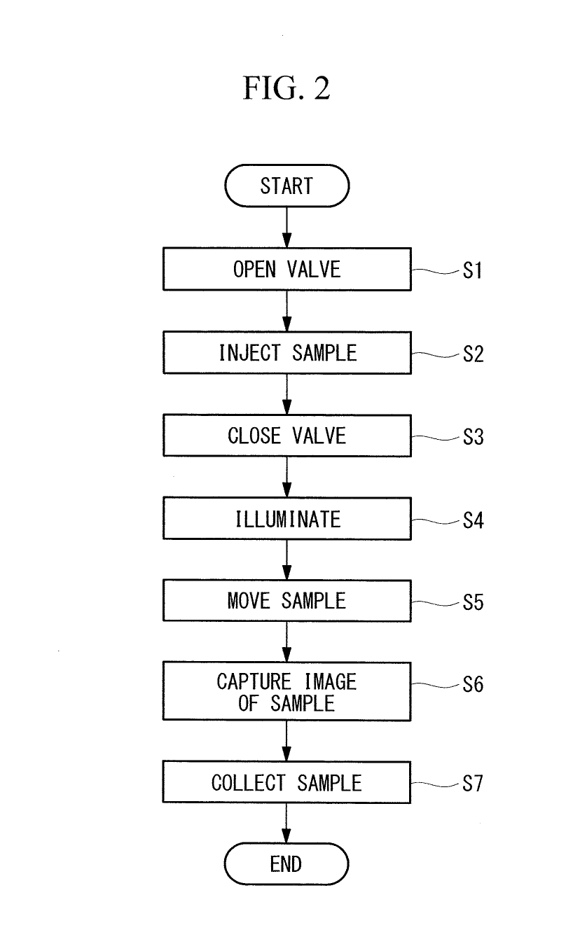

As shown in the flowchart of FIG. 2, a sample observation method according to this embodiment includes: an opening step S1 of opening the valve 17; an injecting step S2 of injecting the samples S into the duct 3; a closing step S3 of closing the valve 17; an illumination step S4 of causing planar illumination light to enter the duct 3 along a plane intersecting the direction in which the samples S flow in the duct 3; a sample moving step S5 of moving the samples S in the duct 3 to cause the samples S to pass through the radiation plane F of the illumination light that has been made to enter the duct 3 in the illumination step S4; an imaging step S6 of acquiring an image of the fluorescence emitted from the samples S having passed through the radiation plane F of the illumination light; and a collection step S7 of collecting the samples S discharged from the duct 3.

The operation of the light-sheet microscope 1 and the sample observation method with this structure will be described below.

When the samples S are to be observed with the light-sheet microscope 1 and by the sample observation method according to this embodiment, the valve 17 is first opened through the control of the control device 14 (opening step S1). Then, through the control of the control device 14, the pipetting robot 19 is driven to inject, via the inlet 4a of the duct 3, the plurality of samples S and the culture fluid L sucked up from a well of the multi-well plate (injecting step S2).

As shown in FIG. 1, the samples S injected via the inlet 4a into the duct 3 move to the bypass section 3b due to the weight thereof via the inlet section 3a and are stored in the bypass section 3b. As a result of the samples S being temporarily stored in the bypass section 3b, not only does it become easy to manage the number of the samples S to be moved by the syringe pump 7 but also the order in which the samples are moved in the duct 3 can be stabilized. When the samples S are stored in the bypass section 3b, the valve 17 is closed by the control device 14 (closing step S3).

In addition, illumination light is emitted from the light source, and the cylindrical lens 9 causes planar illumination light along a plane orthogonal to the direction in which the samples S flow to be incident on a (linear) position just before the duct 3 bends at the bending section 3c (illumination step S4).

Subsequently, the syringe pump 7 is driven by the control device 14 to inject air into the duct 3 via the split section 3e, and the samples S stored in the bypass section 3b move together with the culture fluid L towards the bending section 3c along the duct 3. Due to the syringe pump 7, these samples S are moved at high speed until just before the leading sample S reaches the radiation plane F of illumination light and are moved at low speed just before the leading sample S reaches the radiation plane F (sample moving step S5).

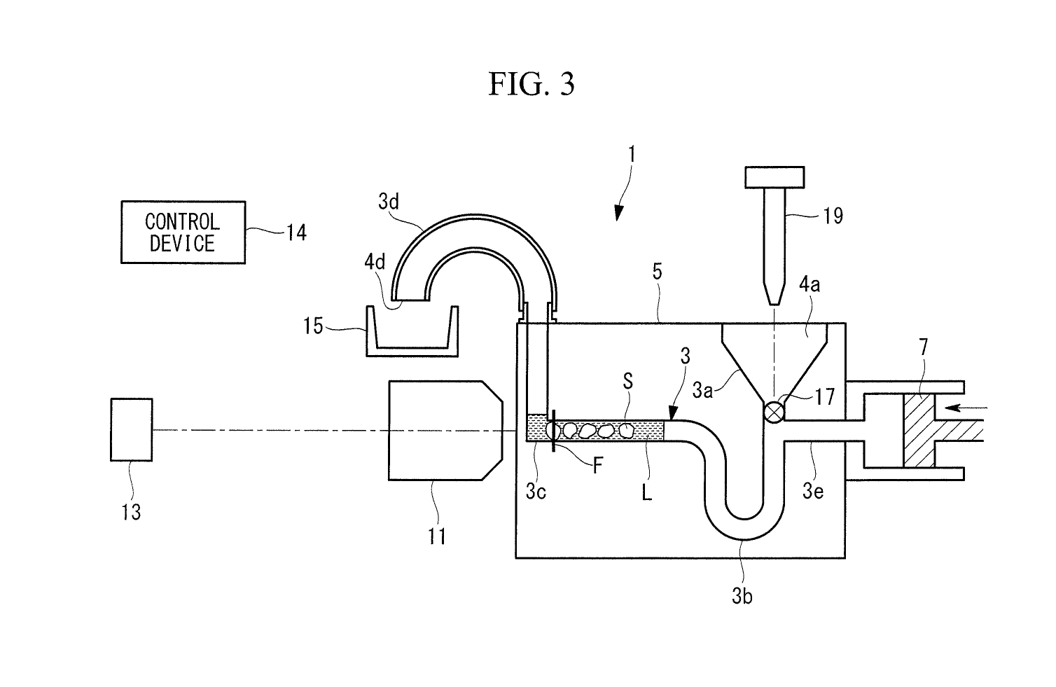

As shown in FIG. 3, when the samples S start to pass through the radiation plane F of illumination light, fluorescent substances in the samples S are excited along the radiation plane F of the illumination light to generate fluorescence. In this case, because the focal plane of the objective lens 11 is aligned with the radiation plane F of illumination light, the fluorescence generated in a wide area along the focal plane of the objective lens 11 can be collected all at once by the objective lens 11.

Furthermore, the camera 13 is driven by the control device 14 in synchronization with the movement of the samples S, so that images of the fluorescence from the samples S collected by the objective lens 11 are acquired by the camera 13 at prescribed time intervals. In this case, the samples S move along the duct 3, and the position of the radiation plane of illumination light in the samples S changes in its moving direction, whereby cross-sectional images intersecting the direction in which the samples S flow are acquired by the camera 13 at a plurality of different positions in the direction in which the samples S move (imaging step S6). By doing so, three-dimensional images of the samples S are acquired simply and accurately, making it possible to observe the samples S in detail.

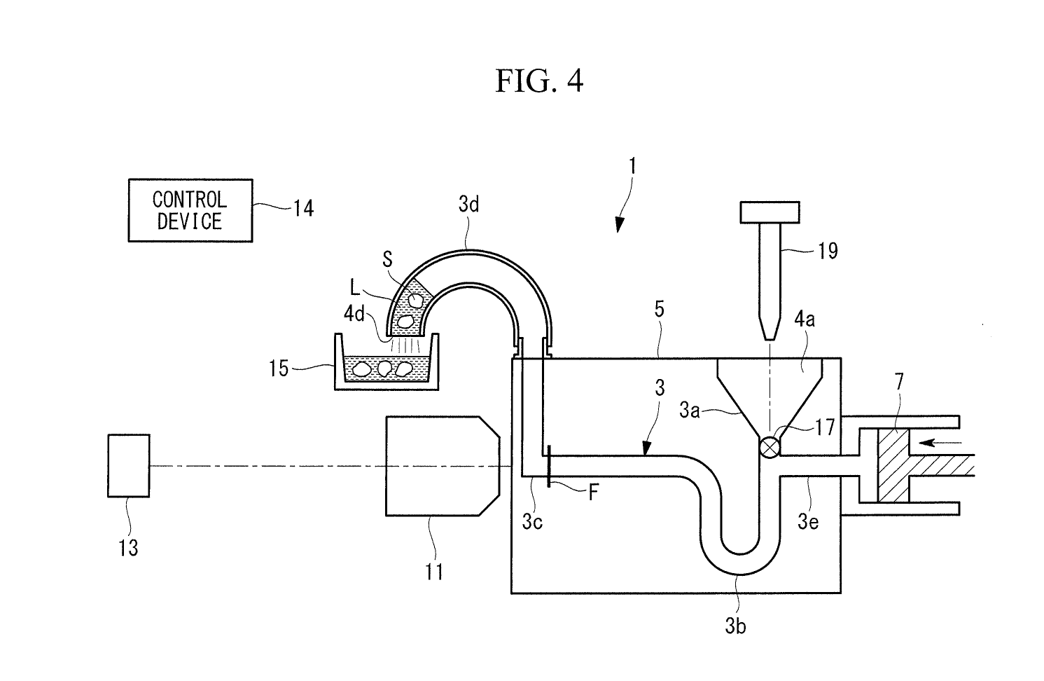

When all the samples S have passed through the radiation plane F of illumination light and imaging of the samples S has finished, the control device 14 switches the speed at which the samples S are moved by the syringe pump 7 to a high speed. Thereafter, as shown in FIG. 4, the samples S are discharged together with the culture fluid L through the outlet 4d of the outlet section 3d and are accommodated in the container 15.

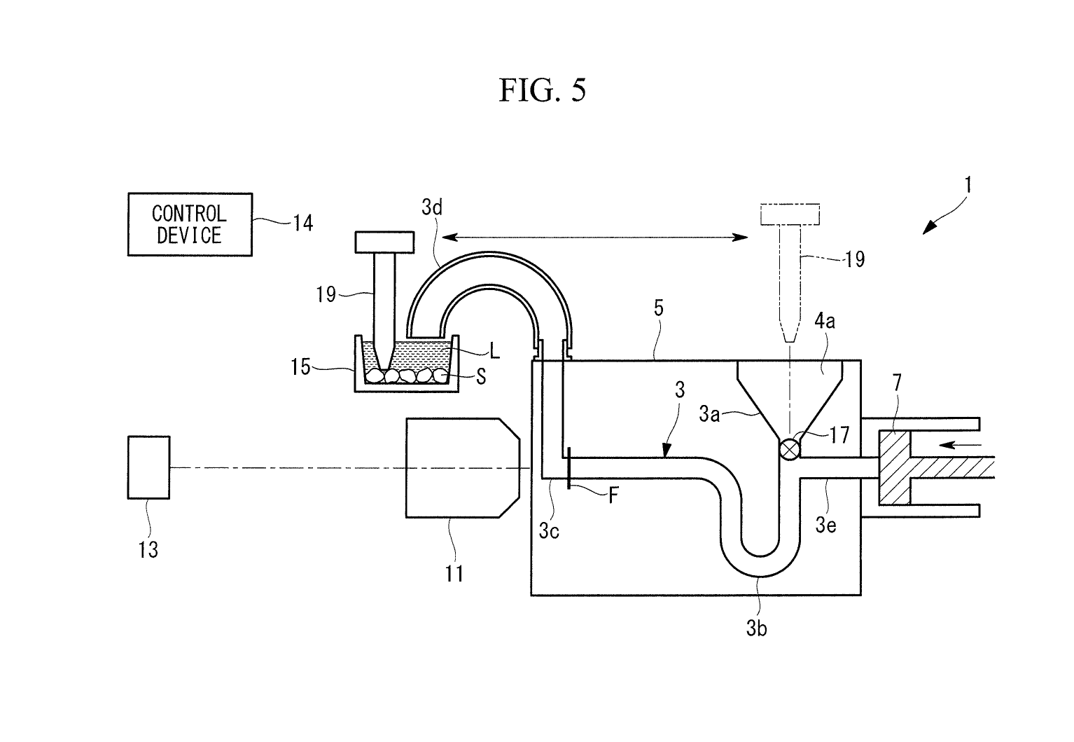

Next, the pipetting robot 19 is driven by the control device 14, and, as shown in FIG. 5, the samples S accommodated in the container 15 are sucked up together with the culture fluid L, thus returning the samples S to the well of the multi-well plate in which the samples S were initially placed (collection step S7). This process is sequentially applied to a plurality of wells of the multi-well plate for observation.

As described above, according to the light-sheet microscope 1 and the sample observation method of this embodiment, the samples move in the duct 3 and pass through the radiation plane F of planar illumination light, and then the position of the radiation plane F of illumination light in the samples S changes in its moving direction, whereby cross-sectional images of the samples S in a direction intersecting the direction in which the samples S move can be acquired at a plurality of different positions in the direction in which the samples S move.

By doing so, three-dimensional images of the samples S are acquired simply and accurately, making it possible to observe the samples in detail. Furthermore, because no areas other than the focal plane of the objective lens 11 are irradiated with illumination light, superior three-dimensional images of the samples S can be acquired by suppressing fluorescent photo bleaching.

This embodiment has been described assuming that the samples S are continuously moved by the syringe pump 7. Instead, the samples S may be, for example, intermittently moved by the syringe pump 7.

In this case, cross-sectional images of the samples S may be acquired at a plurality of different positions in the direction in which the samples S move by repeating the process of operating the camera 13 to acquire images of fluorescence as soon as the samples S stop moving and further moving the samples S by a predetermined distance as soon as the exposure time expires. In this manner, the samples S are not moved within the exposure time of the camera 13, thereby making it possible to acquire more superior images.

### Second Embodiment

A light-sheet microscope and a sample observation method according to a second embodiment of the present invention will now be described.

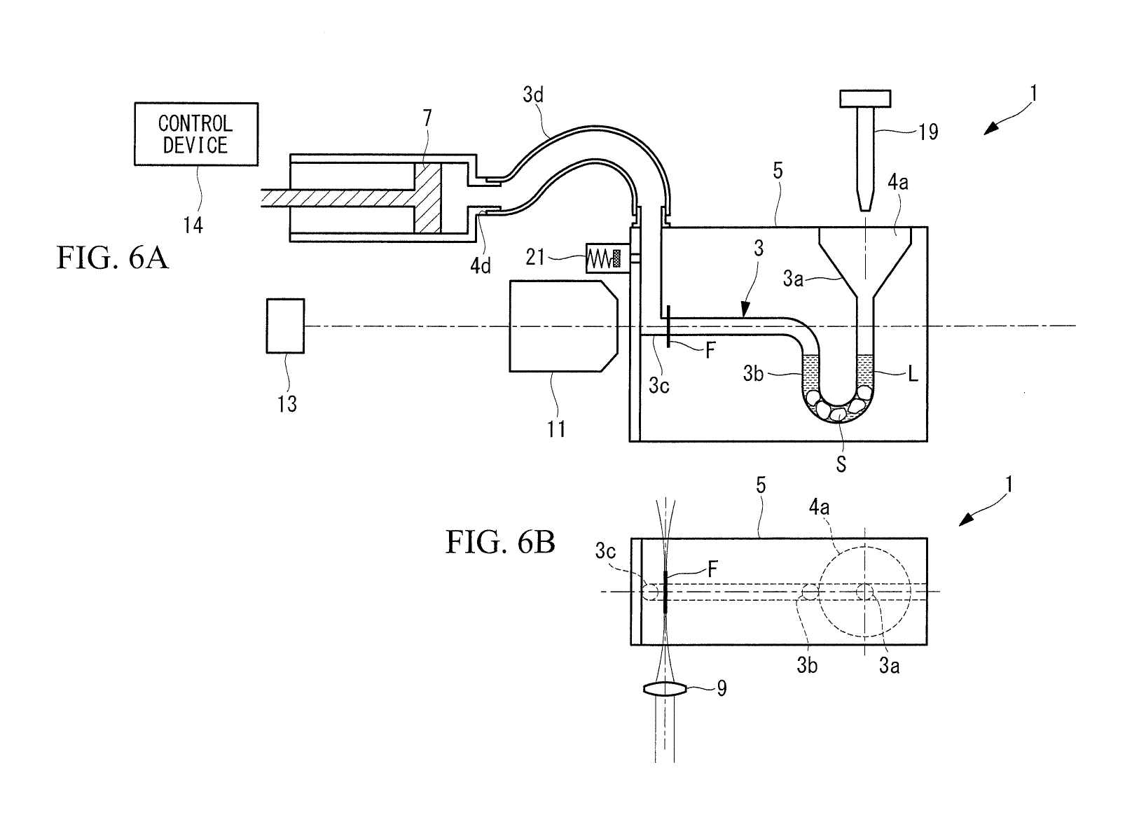

As shown in FIGS. 6A and 6B, a light-sheet microscope 1 according to this embodiment differs from the first embodiment in that the samples S that have been injected into the duct 3 are suctionally attracted towards the discharge side by the syringe pump 7.

In the following description, parts in common with the structures of the above-described light-sheet microscope 1 and the sample observation method according to the first embodiment are denoted with the same reference signs, and a description thereof will be omitted.

In this embodiment, the syringe pump 7 is connected to the outlet 4d of the outlet section 3d. A deaerating valve 21 that can open and close to discharge the air from the duct 3 is provided in the duct 3 between the bending section 3c and the outlet section 3d. The deaerating valve 21 is configured to open and close through the control of the control device 14.

Through the control of the control device 14, this syringe pump 7 suctionally attracts the air in the duct 3 towards the outlet 4d side in a state where the samples S are stored in the bypass section 3b and the deaerating valve 21 is closed. By doing so, the samples S and the culture fluid L stored in the bypass section 3b are moved towards the outlet 4d via the bending section 3c. The moving speed of the samples S through the control of the control device 14 is switched in the same manner as in the first embodiment.

In addition, the sample observation method according to this embodiment is the same as in the first embodiment, and descriptions thereof will be omitted.

The operation of the light-sheet microscope 1 and the sample observation method with this structure will now be described below.

When the samples S are to be observed with the light-sheet microscope 1 and by the sample observation method according to this embodiment, the deaerating valve 21 is first opened through the control of the control device 14 (opening step S1), and the samples S and the culture fluid L are injected by the pipetting robot 19 via the inlet 4a (injecting step S2).

As shown in FIGS. 6A and 6B, the injected samples S and the culture fluid L move to the bypass section 3b via the inlet section 3a due to the weight thereof. When the samples S and the culture fluid L are stored in the bypass section 3b, the deaerating valve 21 is closed by the control device 14 (closing step S3).

In addition, illumination light is emitted from the light source, and the cylindrical lens 9 causes planar illumination light along a plane orthogonal to the direction in which the samples S flow to be incident on a (linear) position just before the duct 3 bends at the bending section 3c (illumination step S4).

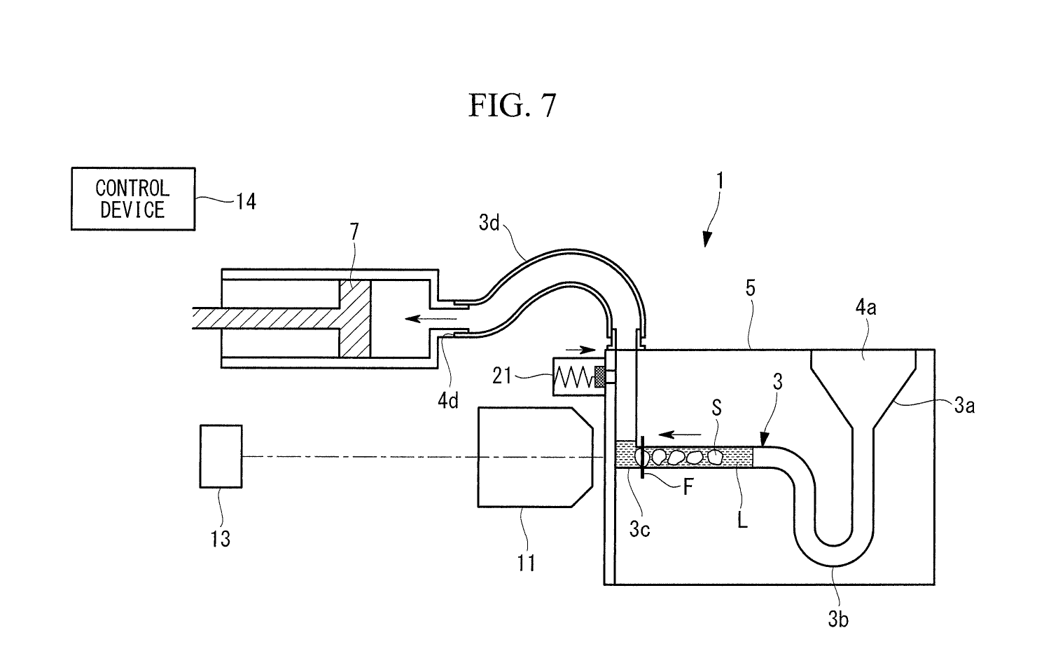

Subsequently, the syringe pump 7 is driven by the control device 14, the air in the duct 3 is suctionally attracted towards the outlet 4d, and the samples S stored in the bypass section 3b move along the duct 3 towards the bending section 3c together with the culture fluid L (sample moving step S5). Then, as shown in FIG. 7, when the samples S start to pass through the radiation plane F of illumination light that has been made to enter the duct 3 in the illumination step S4, images of fluorescence emitted from the samples S are acquired by the camera 13 via the objective lens 11 (imaging step S6).

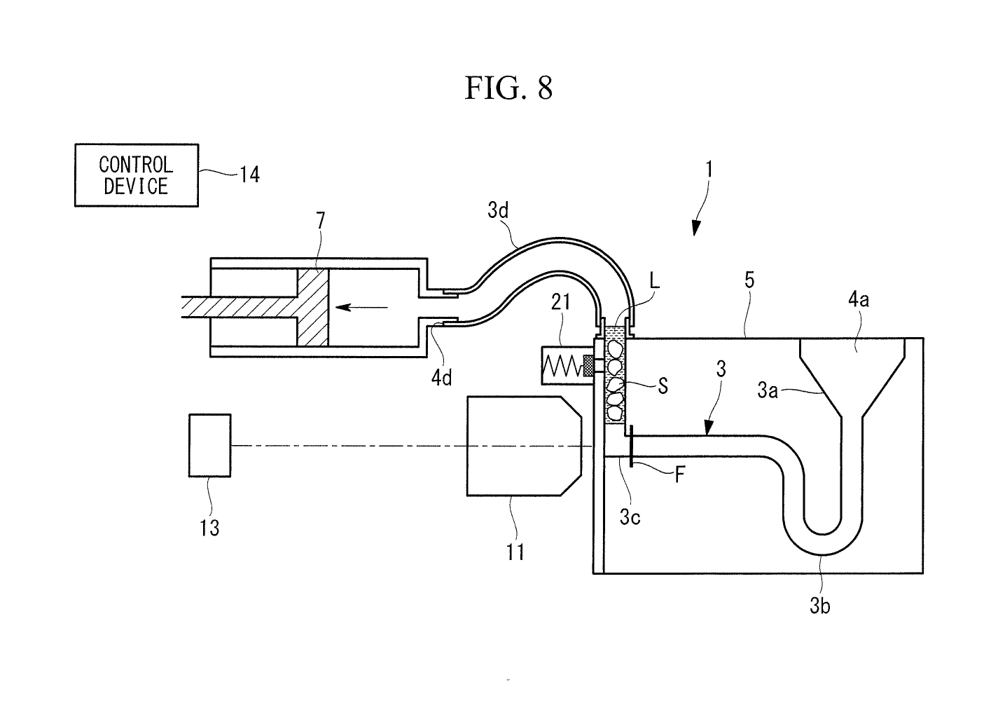

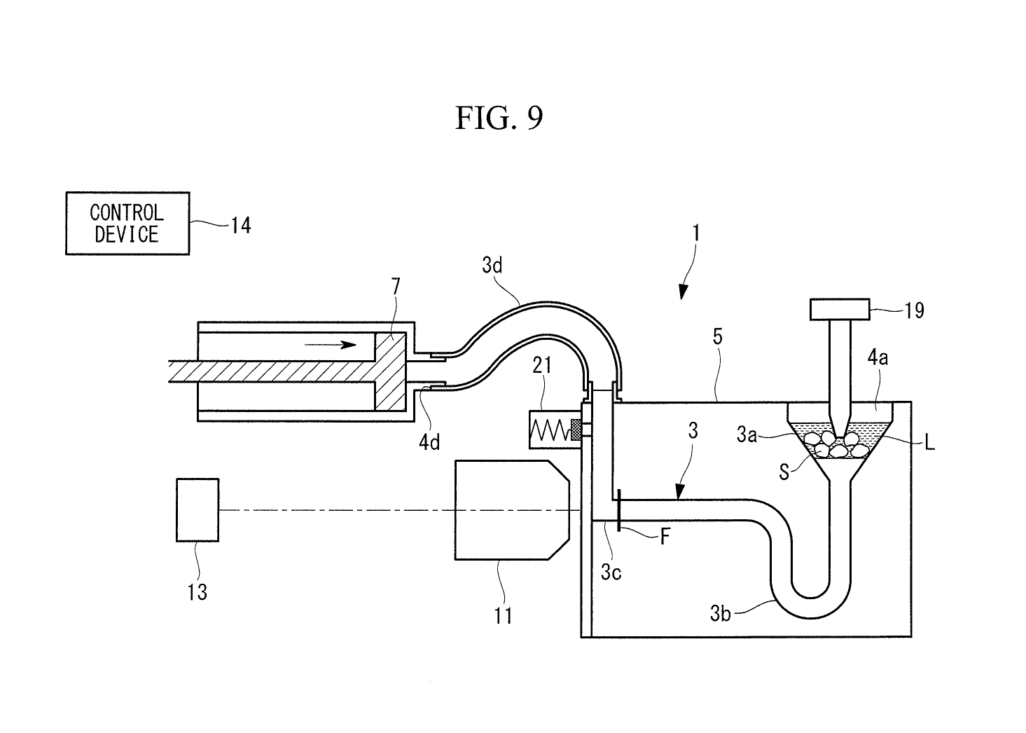

As shown in FIG. 8, when all the samples S have passed through the radiation plane F of illumination light and imaging has finished, driving of the syringe pump 7 is switched by the control device 14, thereby causing the air to be injected into the duct 3 from the outlet 4d side. By doing so, the air in the duct 3 is pushed back from the outlet 4d side to the inlet 4a side to cause the samples S to move in the duct 3 in the reverse direction, and as shown in FIG. 9, the samples S are pushed back to the inlet section 3a.

Thereafter, the pipetting robot 19 is driven by the control device 14, and the samples S are sucked up together with the culture fluid L and are returned to the wells of the multi-well plate where they were initially placed (collection step S7). This process is sequentially applied to a plurality of wells of the multi-well plate for observation.

As described above, according to the light-sheet microscope 1 and the sample observation method of this embodiment, three-dimensional images of the samples S are also acquired simply and accurately by suctionally attracting, on the discharge side, the samples S injected into the duct 3 in the same manner as in the first embodiment, thus making it possible to observe the samples S in detail. In this case, because the syringe pump 7 is connected to the outlet 4d of the duct 3, it is not necessary to provide the split section 3e in the duct 3, thereby making it possible to form the duct 3 into a more simple shape.

Each of the above-described embodiments can be modified as follows.

Although the following modification is described by way of an example of a structure in which the samples S are pushed towards the discharge side by the syringe pump 7 in the same manner as in the first embodiment, this modification may be applied to a structure in which the samples S are suctionally attracted towards the discharge side by the syringe pump 7 as in the second embodiment.

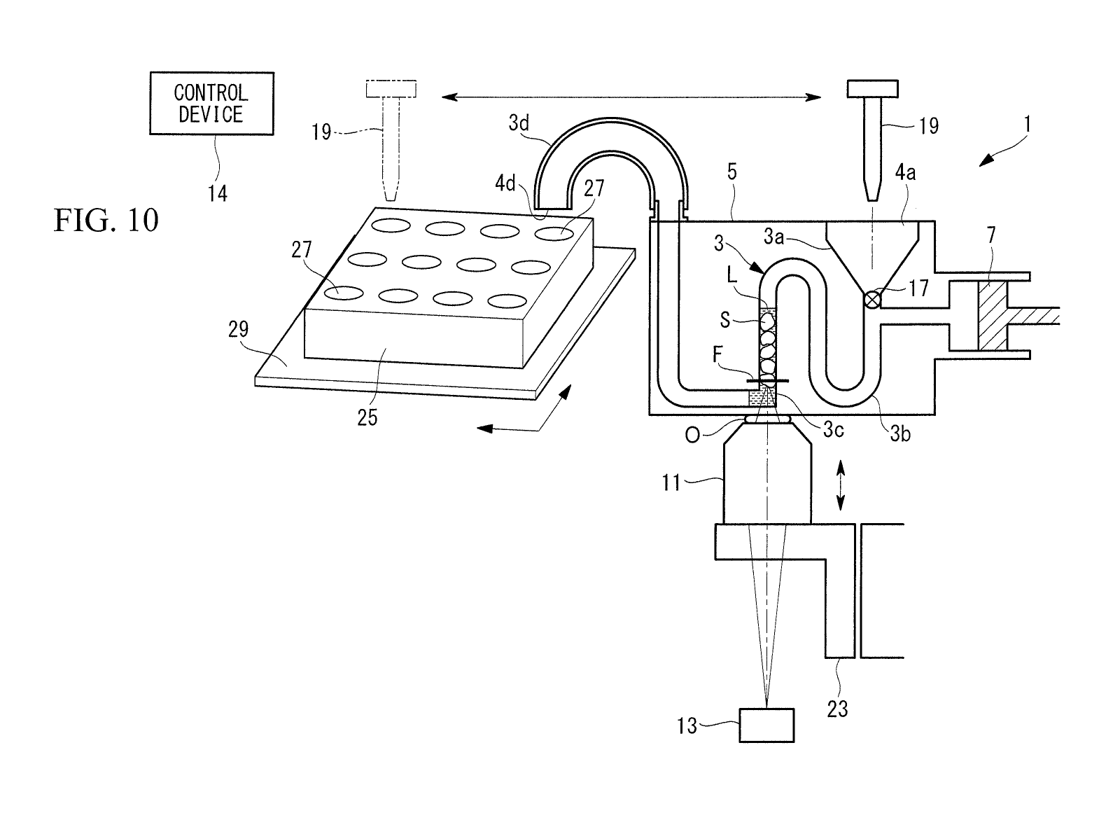

As shown in FIG. 10, in a modification of each of the above-described embodiments, the gap between the objective lens 11 and the casing 5 may be filled with a silicone oil (immersion liquid) O having a refractive index substantially equal to the refractive index of the casing 5.

Because the silicone oil O is non-volatile and stable for an extended period of time, it is almost maintenance-free and allows apparatuses to operate stably for an extended period of time. In this modification, it is preferable that an immersion objective lens be employed as the objective lens 11.

According to this modification, a higher performance can be achieved by allowing the objective lens 11 to collect fluorescence from the samples S via members having a substantially equal refractive index, namely the samples S and the culture fluid L, the transparent member of the duct 3, and the silicone oil O.

Furthermore, as shown in, FIG. 10, the light-sheet microscope 1 may include a targeting part 23 for moving the objective lens 11 in the optical-axis direction. In this case, the control device 14 may be configured to control the targeting part 23.

If the refractive indices of the samples S differ from one another, the focal position of the objective lens 11 may slightly shift for each of the samples S. In such a case, the targeting part 23 allows the focal plane of the objective lens 11 to be accurately aligned with the radiation plane F of illumination light.

In this modification, the targeting part 23 may have an autofocus function for aligning the focal plane of the objective lens 11 with the radiation plane F of illumination light through the control of the control device 14. For the autofocus function, for example, the general contrast method may be used. By doing so, a state where the focal plane of the objective lens 11 is aligned with the radiation plane F of illumination light can be automatically maintained, thereby ensuring superior images to be acquired at all times.

In addition, as shown in FIG. 10 in the same manner, an XY electric drive stage 29 on which the multi-well plate 25 is placed may be employed. In this case, the control device 14 may be configured to control the XY electric drive stage 29. After the samples S in an intended well 27 have been sucked up by the pipetting robot 19 from the multi-well plate 25 and injected into the duct 3 and the imaging process has completed, the XY electric drive stage 29 may be driven to move the multi-well plate 25 closer to the outlet 4d of the duct 3 so that the samples S can be collected in the well 27 where the samples S were initially placed.

By doing so, because the container that intervenes during the observation process can be eliminated, contamination from other samples S can be prevented. This is advantageous because culture can be continued as is.

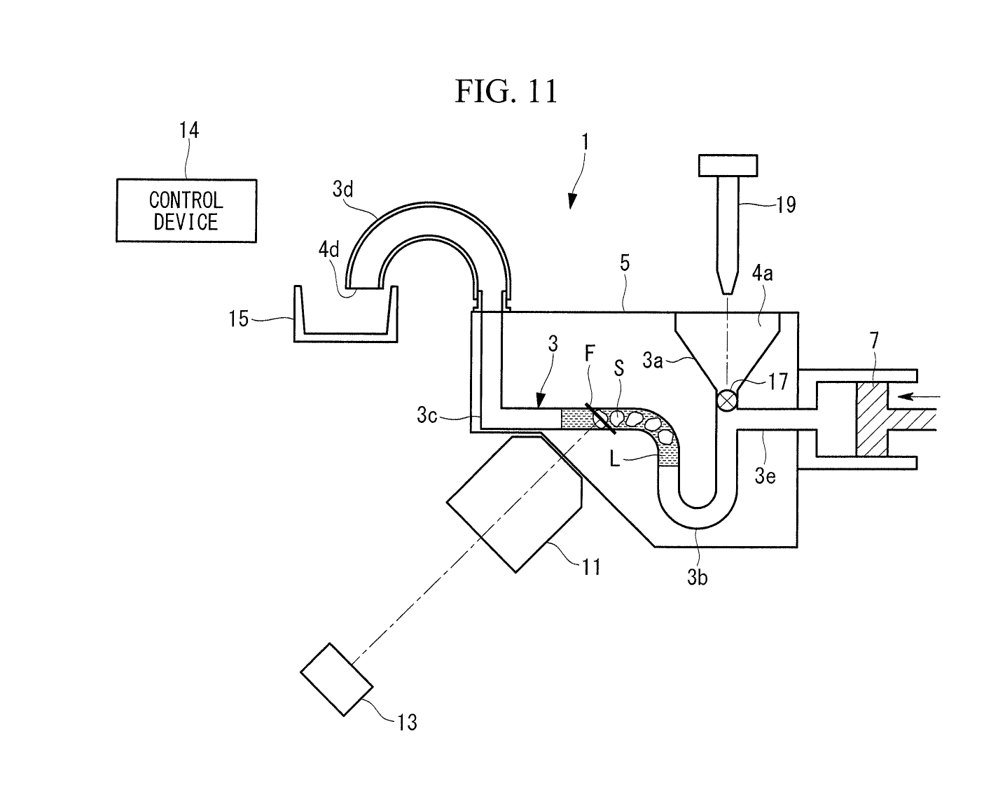

In addition, although in each of the above-described embodiments, planar illumination light along a plane orthogonal to the direction in which the samples S move is made to enter the duct 3 via the cylindrical lens 9, it is advisable to cause planar illumination light along a plane intersecting the direction in which the samples S move to enter the duct 3 via the cylindrical lens 9, as shown in FIG. 11. FIG. 11 shows a case where planar illumination light along a plane tilted by about 45° relative to the direction in which the samples S move is made to be incident on the duct 3.

In this case, it is advisable to place the objective lens 11 so as to face the radiation plane F of illumination light, which enters the duct 3 via the cylindrical lens 9, and to align the focal plane with the radiation plane F of illumination light. Also in this case, in the same manner as in each of the above-described embodiments, the samples S flowing in the duct 3 pass through the radiation plane F of illumination light, whereby fluorescence generated in a wide area along the focal plane of the objective lens 11 in the samples S can be collected by the objective lens 11 all at once, so that the camera 13 can acquire images.

Although the embodiments of the present invention have been described in detail with reference to the drawings, the specific structure is not limited to those of these embodiments but includes design changes etc. that do not depart from the spirit of the present invention. The present invention is not limited to the invention applied to each of the above-described embodiments and modification but can be applied to, for example, embodiments in which these embodiments and the modification are appropriately combined and is not particularly limited. Although each of the above-described embodiments has been described assuming that the multi-well plate 25 is used as a container in which the samples S are cultured, the samples S may be accommodated in pipette tips or cuvettes in an arranged manner.

In addition, although each of the above-described embodiments has been described by way of an example of a structure in which the duct 3 is formed as a through-hole formed in the casing 5, the duct 3 may be formed as a tube, instead. In this case, it is advisable that at least the tube area that the cylindrical lens 9 faces and/or the tube area that the objective lens 11 faces be formed of a transparent member having a refractive index substantially equal to the refractive index of the samples S and the culture fluid L.

Furthermore, although each of the above-described embodiments has been described assuming that the cross section of the duct 3 is circular because substantially spherical spheroids are used as the samples S, it is advisable that the cross section of the duct 3 be changed, as appropriate, in accordance with the shape of a sample so that the sample can easily flow.

In each of the above-described embodiments, illumination light emitted from the light source is focused by the cylindrical lens 9 into the shape of a sheet along a plane along the illumination light axis, thereby generating planar illumination light along a plane orthogonal to the direction in which the samples S move. Instead, for example, a linear beam may be focused via an axially symmetric lens (not shown in the figure) along the illumination light axis and then scanned by the use of light deflecting means (not shown in the figure), like a galvanometer scanner, in a direction orthogonal to both the direction along the illumination light axis and the direction in which the samples S move, thus generating planar illumination light. In this case, it is advisable that one observation surface be scanned within the exposure time of the camera 13.

In addition, although in each of the above-described embodiments, illumination light is focused by the cylindrical lens 9 into the shape of a sheet having an area larger than the observation field of view, a beam may be focused, for example, by a cylindrical lens into the shape of a sheet having an area smaller than the observation field of view (the size of the observation field of view), and then the sheet-shaped beam may be scanned by the use of light deflecting means (not shown in the figure) in a direction orthogonal to both the direction along the illumination light axis and the direction in which the samples S move.

The following invention is derived from the above-described embodiments.

One aspect of the present invention is a light-sheet microscope including: a duct in which a sample can flow; a sample moving part for moving the sample in the duct; an illuminating section for causing planar illumination light along a plane intersecting the direction in which the sample is moved by the sample moving part to enter the duct; an objective lens that is disposed so as to face a radiation plane of the illumination light caused by the illuminating section to enter the duct and that collects light emitted from the sample moved by the sample moving part so as to pass through the radiation plane of the illumination light; and an image-capturing unit for acquiring an image of the light that comes from the sample and that is collected by the objective lens.

According to this aspect, when the sample is moved by the sample moving part in the duct and passes through the radiation plane of planar illumination light that has been made to enter the duct by the illuminating section, light is emitted from the radiation plane of the illumination light in the sample.

Therefore, by aligning the focal plane of the objective lens with the radiation plane of illumination light, it is possible to allow the objective lens to collect, all at once, light that is generated in a wide area along the focal plane of the objective lens and then acquire an image with the image-capturing unit. Thereafter, the sample moves along the duct, and the position of the radiation plane of illumination light in the sample changes in its moving direction, whereby cross-sectional images of the sample in a direction intersecting the sample moving direction can be acquired at a plurality of different positions in the sample moving direction.

Because of this, a three-dimensional image of the sample is acquired simply and accurately, thereby making it possible to observe the sample in detail. In addition, because no areas other than the focal plane of the objective lens are irradiated with illumination light, photo bleaching of light is suppressed, thereby making it possible to acquire superior three-dimensional images of the sample.

In the above-described aspect, the sample moving part may continuously or intermittently move the sample along the duct, and the image-capturing unit may acquire, at prescribed time intervals, a plurality of images of the sample passing through the radiation plane of the illumination light.

With this structure, cross-sectional images of the sample can be acquired at a plurality of different positions in the sample moving direction according to the relationship between the distance by which the sample is moved by the sample moving part and the time intervals at which images are acquired by the image-capturing unit.

In the above-described aspect, the sample moving part may continuously move the sample such that a focal range of the objective lens is not exceeded within an exposure time of the image-capturing unit.

With this structure, highly accurate three-dimensional images of the sample can be acquired.

In the above-described aspect, the duct may have a bending section that bends in a direction intersecting the optical axis of the objective lens between the radiation plane of the illumination light and the objective lens.

With this structure, the duct can be prevented from restricting the arrangement of the objective lens, thereby making it possible to easily arrange the objective lens so that the focal plane coincides with the radiation plane of illumination light.

In the above-described aspect, the duct may have an inlet via which the sample is injected and a bypass section that runs at a vertically lower point than the radiation plane of the illumination light.

With this structure, when a plurality of samples injected via the inlet into the duct move to the bypass section, the samples are temporarily stored in the bypass section due to the weight thereof. By doing so, not only does it become easier to control the number of the samples moved by the sample moving part, but also the order in which the samples move along the duct can be stabilized.

In the above-described aspect, the bypass section may have a volume larger than the gross volume of an injected material, including the sample, that is injected in one batch.

With this structure, it is possible to prevent the samples, temporarily stored in the bypass section, from overflowing from the bypass section.

In the above-described aspect, the sample moving part may be a pump mechanism that pushes the sample injected into the duct towards a discharge side of the sample or suctionally attracts the sample injected into the duct towards the discharge side of the sample.

With this structure, the sample can be easily moved in the duct with a simple structure in which the sample is merely pushed or suctionally attracted by the pump mechanism.

In the above-described aspect, the sample moving part may be a pump mechanism for pushing the sample injected into the duct towards a discharge side, and the duct may include a valve between the inlet and an opening of the pump mechanism.

With this structure, the sample is injected into the duct via the inlet by opening the valve, and the sample is pushed by the pump mechanism by closing the valve. Therefore, it is possible to easily switch between sample injection and sample movement by opening and closing the valve.

The above-described aspect may include a container-placing part on which a container that can accommodate the sample can be placed, wherein the duct may have an outlet via which the sample that has passed through the radiation plane of the illumination light is discharged, and the outlet may be disposed in the vicinity of the container-placing part.

With this structure, the container is placed on the container-placing part, whereby the sample discharged via the outlet of the duct can easily be collected in the container. The container may be the one that has accommodated the sample before being injected into the duct.

In the above-described aspect, the sample may be a cultured cell having a three-dimensional structure and may be made to flow in the duct together with a culture fluid.

With this structure, a three-dimensional image of the sample in a state substantially identical to a state in which the sample is cultured in a culture fluid can be acquired.

In the above-described aspect, at least an area in the duct that the illuminating section faces and/or the objective lens faces may be formed of a transparent member having a refractive index substantially equal to the refractive index of a liquid that is injected into the duct together with the sample.

With this structure, it is possible to acquire a highly accurate image of the sample with a reduced effect of the difference in refractive index between the area that the illuminating section or the objective lens faces and the liquid in the duct.

In the above-described aspect, the duct may be formed of a through-hole in a casing composed of a transparent member having a refractive index substantially equal to the refractive index of a liquid that is injected into the duct together with the sample.

With this structure, it is possible to acquire a highly accurate image of the sample with a reduced effect of the difference in refractive index between the area that the illuminating section or the objective lens faces and the liquid in the casing.

In the above-described aspect, the duct may be shaped so as to bend only in one plane intersecting the radiation plane of the illumination light.

With this structure, the duct can be formed of a through-hole of simple shape in the casing.

In the above-described aspect, the casing may be formed by laminating at least two casing-forming members divided along a longitudinal direction of the duct.

With this structure, the duct can be made of grooves formed in a plurality of casing-forming members. In this case, because the duct is shaped so as to bend only in one plane intersecting the radiation plane of illumination light, the grooves to be formed in the casing-forming member can take a simple shape.

In the above-described aspect, the objective lens may be an immersion objective lens, and the gap between the transparent member and the objective lens may be filled with an immersion liquid having a refractive index substantially equal to the refractive index of the transparent member.

With this structure, the immersion objective lens collects light from the sample via members having substantially equal refractive index, namely the liquid to be injected into the duct together with the sample, the transparent member of the duct, and the immersion liquid, thereby allowing higher performance to be achieved.

In the above-described aspect, the immersion liquid may be non-volatile.

With this structure, the amount of immersion liquid can be prevented from decreasing due to evaporation.

The above-described aspect may further include a targeting part for moving the objective lens in an optical-axis direction.

With this structure, the position of the focal plane of the objective lens in the optical-axis direction can be precisely adjusted by the targeting part relative to the radiation plane of illumination light.

In the above-described aspect, the targeting part may have an autofocus function for adjusting an in-focus state in the optical-axis direction of the objective lens to the radiation plane of the illumination light.

With this structure, it is possible to automatically maintain a state where the focal plane of the objective lens is aligned with the radiation plane of illumination light.

In this aspect, the light emitted from the sample may be fluorescence.

Another aspect of the present invention is a sample observation method including: injecting a sample into a duct; causing planar illumination light along a plane intersecting a flow direction of the sample in the duct to enter the duct; moving the sample in the duct so that the sample passes through a radiation plane of the illumination light caused to enter the duct; and acquiring an image of light emitted from the sample passing through the radiation plane of the illumination light.

According to this aspect, when the sample injected into the duct and flowing in the duct passes through the radiation plane of the planar illumination light that has been made to enter the duct, light is emitted from the radiation plane of the illumination light in the sample.

Therefore, by aligning the focal plane of the objective lens with the radiation plane of the illumination light, it is possible to collect, all at once, the light that is generated in a wide area along the focal plane of the objective lens to acquire an image of the light. Then, the sample passes through the radiation plane of illumination light, whereby it is possible to acquire, at a plurality of different positions in the sample moving direction, cross-sectional images of the sample in a direction intersecting the sample moving direction.

By doing so, three-dimensional images of the sample are acquired simply and accurately, thereby making it possible to observe the sample in detail. Furthermore, because no areas other than the focal plane of the objective lens are irradiated with illumination light, photo bleaching of light is suppressed, thereby making it possible to acquire superior three-dimensional images of the sample.

In the above-described aspect, when the sample is moved in the duct, the sample may be continuously or intermittently moved along the duct, and when the image of the light emitted from the sample is acquired, a plurality of images of the sample passing through the radiation plane of the illumination light may be acquired at prescribed time intervals.

With this structure, cross-sectional images of the sample in a direction intersecting the direction in which the sample flows can be acquired at a plurality of different positions in the sample moving direction, according to the relationship between the sample moving distance and the time intervals at which images are acquired.

In the above-described aspect, the light emitted from the sample may be fluorescence.

### REFERENCE SIGNS LIST

1 Light-sheet microscope
3 Duct
3b Bypass section
3c Bending section
4a Inlet
4d Outlet
7 Syringe pump (sample moving part)
9 Cylindrical lens (illuminating section)
11 Objective lens
13 Camera (image-capturing unit)
17 Valve
23 Alignment part
S2 Injecting step
S4 Illumination step
S5 Sample moving step
S6 Imaging step
L Culture fluid (liquid)
O Silicone oil (immersion liquid)
S Sample (specimen)

1. A light-sheet microscope comprising:
a duct in which a sample can flow;
a sample moving part for moving the sample in the duct;
an illuminating section for causing planar illumination light along a plane intersecting the direction in which the sample is moved by the sample moving part to enter the duct;
an objective lens that is disposed so as to face a radiation plane of the illumination light caused by the illuminating section to enter the duct and that collects light emitted from the sample moved by the sample moving part so as to pass through the radiation plane of the illumination light; and
an image-capturing unit for acquiring an image of the light that comes from the sample and that is collected by the objective lens.

2. The light-sheet microscope according to claim 1,
wherein the sample moving part continuously or intermittently moves the sample along the duct, and
the image-capturing unit acquires, at prescribed time intervals, a plurality of images of the sample passing through the radiation plane of the illumination light.

3. The light sheet microscope according to claim 2, wherein the sample moving part continuously moves the sample such that a focal range of the objective lens is not exceeded within an exposure time of the image-capturing unit.

4. The light-sheet microscope according to claim 1, wherein the duct has a bending section that bends in a direction intersecting the optical axis of the objective lens between the radiation plane of the illumination light and the objective lens.

5. The light-sheet microscope according to claim 1, wherein the duct has an inlet via which the sample is injected and a bypass section that runs at a vertically lower point than the radiation plane of the illumination light.

6. The light-sheet microscope according to claim 5, wherein the bypass section has a volume larger than the gross volume of an injected material, including the sample, that is injected in one batch.

7. The light-sheet microscope according to claim 1, wherein the sample moving part is a pump mechanism that pushes the sample injected into the duct towards a discharge side of the sample or suctionally attracts the sample injected into the duct towards the discharge side of the sample.

8. The light-sheet microscope according to claim 5,
wherein the sample moving part is a pump mechanism for pushing the sample injected into the duct towards a discharge side, and
the duct includes a valve between the inlet and an opening of the pump mechanism.

9. The light-sheet microscope according to claim 1, comprising:
a container-placing part on which a container that can accommodate the sample can be placed,
wherein the duct has an outlet via which the sample that has passed through the radiation plane of the illumination light is discharged, and
the outlet is disposed in the vicinity of the container-placing part.

10. The light-sheet microscope according to claim 1, wherein the sample is a cultured cell having a three-dimensional structure and is made to flow in the duct together with a culture fluid.

11. The light-sheet microscope according to claim 1, wherein, in the duct, at least an area that the illuminating section faces and/or the objective lens faces is formed of a transparent member having a refractive index substantially equal to the refractive index of a liquid that is injected into the duct together with the sample.

12. The light-sheet microscope according to claim 1, wherein the duct is formed of a through-hole in a casing composed of a transparent member having a refractive index substantially equal to the refractive index of a liquid that is injected into the duct together with the sample.

13. The light-sheet microscope according to claim 1, wherein the duct is shaped so as to bend only in one plane intersecting the radiation plane of the illumination light.

14. The light-sheet microscope according to claim 13, wherein the casing is formed by laminating at least two casing-forming members divided along a longitudinal direction of the duct.

15. The light-sheet microscope according to claim 12,
wherein the objective lens is an immersion objective lens, and
the gap between the transparent member and the objective lens is filled with an immersion liquid having a refractive index substantially equal to the refractive index of the transparent member.

16. The light-sheet microscope according to claim 15, wherein the immersion liquid is non-volatile.

17. The light-sheet microscope according to claim 1, further comprising: a targeting part for moving the objective lens in an optical-axis direction.

18. The light-sheet microscope according to claim 17, wherein the targeting part has an autofocus function for adjusting an in-focus state in the optical-axis direction of the objective lens to the radiation plane of the illumination light.

19. The light-sheet microscope according to claim 1, wherein the light emitted from the sample is fluorescence.

20. A sample observation method comprising:
injecting a sample into a duct;
causing planar illumination light along a plane intersecting a flow direction of the sample in the duct to enter the duct;
moving the sample in the duct so that the sample passes through a radiation plane of the illumination light caused to enter the duct; and
acquiring an image of light emitted from the sample passing through the radiation plane of the illumination light.

21. The sample observation method according to claim 20,
wherein when the sample is moved in the duct, the sample is continuously or intermittently moved along the duct, and
when the image of the light emitted from the sample is acquired, a plurality of images of the sample passing through the radiation plane of the illumination light are acquired at prescribed time intervals.

22. The sample observation method according to claim 20, wherein the light emitted from the sample is fluorescence.
